(19) United States
(12) Patent Application Publication
(10) Pub. No.: US 2007/0028159 A1
(43) Pub. Date: Feb. 1, 2007

(54) CHANGE-ORIENTED ELECTRONIC SPREADSHEET APPLICATION

(76) Inventors: Rui Su Ying, Beijing (CN); Wang FengLi, Beijing (CN)

Correspondence Address: HOFFMAN, WARNICK & D'ALESSANDRO LLC, 75 STATE ST, 14TH FLOOR, ALBANY, NY, 12207, US

(21) Appl. No.: 11/428,389

(22) Filed: Jul. 1, 2006

(30) Foreign Application Priority Data
Jul. 27, 2005 (CN) 200510087171.3

(51) Int. Cl. G06F 17/00

(52) U.S. Cl. 715/503

(57) ABSTRACT

The present invention provides a change-oriented method for organizing electronic spreadsheet data, comprising: saving the contents of the cells in the electronic spreadsheet and valid updates into the same electronic spreadsheet document, wherein the valid updates comprise the updates to the contents of the cells and the time information associated with these updates. With the invention, every valid update of a cell comprising the time information can be recorded in the electronic spreadsheet document, so as to provide a basis for applications of electronic spreadsheets, such as taking a snapshot, obtaining a chart of the historical information and so on. In addition, the present invention also provides a method for taking a snapshot of an electronic spreadsheet document at a given time, a method for obtaining the historical information of an electronic spreadsheet document in a given time period and a change-oriented electronic spreadsheet system.

### FIELD OF THE INVENTION

The present invention relates to electronic spreadsheet applications, and more specifically relates to spreadsheet applications oriented to changes of the spreadsheet documents, including: a change-oriented method for organizing data of an electronic spreadsheet, a method for taking a snapshot of an electronic spreadsheet document at a given time and a method for obtaining the historical information of contents in an electronic spreadsheet document in a given time period, as well as the corresponding systems.

### BACKGROUND OF THE INVENTION

At present, electronic spreadsheet software applications are widely used in many fields. A common use is for enterprises to periodically generate reports, such as those in the financial field. Electronic spreadsheet reports with similar or the same templates are required to be submitted monthly, weekly or even daily. Further, accountants also need to build salary reports each month according to the same template.

Especially in small or medium enterprises, because of limited system resources, electronic spreadsheet application programs are typically used for storing and managing data in place of relational databases that are more powerful but have higher requirements on the system resources. Relational databases are powerful in functionality but very expensive, with very high development and maintenance costs, which is why small and medium enterprises sometimes use electronic spreadsheet software for data storage and maintenance. For instance, in an application scenario of warehouse management, with a traditional electronic spreadsheet application, a warehouse keeper needs to generate stock spreadsheets periodically for querying. This has at least two problems. First, time granularity of querying is limited. Changes of stock information that have occurred in the interval between two specified times of saving the information cannot be queried; second, the warehouse keeper needs to maintain a plurality of electronic spreadsheet documents to ensure the stock information in a past period of time is able to be queried. Regularly or irregularly saving data into electronic spreadsheets is not only required in a scenario of warehouse management mentioned above, but also a researcher may need to generate a spreadsheet for each experiment; an accountant may need to record the company workers'salaries periodically; a teacher may need to keep the students'scores after each examination; and so on. Thus, the above-mentioned problems may occur in all of these applications.

At present, if a user uses a traditional electronic spreadsheet application in the above-mentioned scenarios, the usual way is to generate templates, copy/paste areas/sheets in electronic spreadsheet documents and so on. After that, the user can only provide regular reports separately on the basis of these templates. Querying/summarization of these reports is a tough job, because data in different periods are saved separately, though these data are all about a same thing. And unfortunately, such scenarios occur frequently.

In the prior-of art spreadsheet applications, valid changes of data in an electronic spreadsheet are often discarded, so only the current value of every item is recorded in the electronic spreadsheet document. Thus, some useful operations on the collection of data cannot be performed conveniently.

U.S. Pat. No. 5,806,078, “Version Management System”, discloses a method for controlling versions of content in an electronic document. With this method, different versions of the document content are saved in the electronic document editing software in the manner of incremental saves, and the different versions are generated on the basis of the incrementally saved content, so that the historical information can be queried according to the version numbers. However, because there are many kinds of electronic document editing software, such as electronic spreadsheets, electronic films, electronic word processing, etc., saving changes of the content of an electronic document in the manner of incremental saving does not constitute an independent semantic meaning.

Three U.S. Pat. Nos. 5,449,180, 5,303,146 and 6,438,565B1, “System and Methods for Improved Scenario Management in an Electronic Spreadsheet”, disclose an improved method and system with scenario management functions in electronic spreadsheet applications and describe the improved method from different aspects, respectively. With this method, first a user defines a specified area in an electronic spreadsheet document and base values for the cells in the area. After that the user modifies the values in the specified area, and the electronic spreadsheet application automatically compares the user's modifications with the base values. If there is any difference the changes will be recorded; at the same time, the electronic spreadsheet application automatically updates the values of other cells dependent on these modified values, such as the values in formula cells. If the values in these cells are updated, the electronic spreadsheet application will automatically indicate to the user, such as by highlighting. At this time, the current values in the specified area and the current values in the cells associated therewith are called a scenario. Furthermore, the electronic spreadsheet application can effectively record these scenarios and provide the query function.

However, in the methods provided by the above-mentioned patents, time information is not included in the saved changes of content of an electronic spreadsheet document, so querying historic information is time independent.

U.S. Pat. No. 5,926,822, “Transformation of Real Time Data into Time Series and Filtered Real Time Data within a Spreadsheet Application”, describes a extended function of an electronic spreadsheet application, which can process real time data, that is, the expanded electronic spreadsheet application can receive real time data series and save them in the computer memory. Besides, existing formula functions in the electronic spreadsheet application can be used to perform filtering and simple calculations on the real time data series saved in the memory. Although the data objects processed by this patent include data and the corresponding times, these times come from outside of the electronic spreadsheet application.

Therefore, the present invention introduces a “time” dimension into electronic spreadsheet applications so as to effectively solve the above-mentioned problems that may exist in electronic spreadsheet applications.

### SUMMARY OF THE INVENTION

The present invention provides a change-oriented method for organizing electronic spreadsheet data, so that when an electronic spreadsheet is updated (changed), not only the original content but also the updated content and time information associated with the updating are recorded.

The present invention also provides a method for taking a snapshot of an electronic spreadsheet document at a given time, wherein the valid updates on the electronic spreadsheet document have been recorded in the electronic spreadsheet document using the above-mentioned method.

The present invention also provides a method for obtaining the historical information of the content in an electronic spreadsheet document in a given time period, wherein the valid updates on the electronic spreadsheet document have been recorded in the electronic spreadsheet document using the above-mentioned method. The historical information obtained with this method comprises the updated contents in the given time period and the time information associated with these updates, which may be used as a data source for data analysis in electronic spreadsheet software and the inputs of formulas in an electronic spreadsheet, etc. In addition, the historical information may be presented in visual charts.

The present invention also provides a change-oriented electronic spreadsheet system to implement the above-mentioned methods.

According to an aspect of the present invention, there is provided a change-oriented method for organizing electronic spreadsheet data, comprising: saving contents of cells in the electronic spreadsheet and valid updates into the same electronic spreadsheet document, wherein the valid updates comprise updates to the contents of the cells and time information associated with the updates.

Preferably, in the change-oriented method for organizing electronic spreadsheet data according to the present invention, the time information associated with updates is the occurrence times of the valid updates.

Preferably, in the change-oriented method for organizing electronic spreadsheet data according to the present invention, the valid updates are saved as auxiliary information of the corresponding cells in order of the occurrence times of the updates.

Preferably, in the change-oriented method for organizing electronic spreadsheet data according to the present invention, the valid updates are saved according to the update times and separately from the contents of the cells, and the binding relationships between the valid updates and the corresponding cells are also saved.

Preferably, in the change-oriented method for organizing electronic spreadsheet data according to the present invention, the valid updates are saved according to the occurrence times of the updates as given by timestamps and separately from the contents of the cells, and the binding relationships between the valid updates and the corresponding cells are also saved.

Preferably, the change-oriented method for organizing electronic spreadsheet data according to the present invention further comprises: specifying by the user whether the valid updates are recorded for the whole electronic spreadsheet document or a spreadsheet, an area, a column, or a cell.

According to another aspect of the present invention, there is provided a method for taking a snapshot of an electronic spreadsheet document at a given time, wherein the change-oriented method for organizing electronic spreadsheet data has been applied in the electronic spreadsheet document, the method comprising the following steps:
getting the area of the electronic spreadsheet document of which a snapshot is to be taken and a timestamp;
searching every cell in the area to determine whether or not there is any saved valid update;
if the answer is “yes”, obtaining the latest valid update of every cell corresponding to the specified timestamp;
applying the obtained valid updates to every corresponding cell; and
if no cell has any saved valid update or the above processing step has been performed for every cell, the process of taking a snapshot of the electronic spreadsheet document is ended.

Preferably, the step of obtaining the latest valid update of every cell corresponding to the specified timestamp comprises:
scanning all the valid updates of the cell;
if the update occurrence time corresponding to a valid update is smaller than the timestamp and the update occurrence time corresponding to the subsequent valid update is larger than the timestamp or there is no valid update later in order of time, then this valid update is the latest valid update of the cell corresponding to the specified timestamp; and
if the latest valid update of the cell corresponding to the specified timestamp is found, the scanning is ended.

It should be noted that, if all valid updates of the cell have been put in order effectively, for instance, according to the occurrence times of the updates, the latest valid update of the cell corresponding to the specified timestamp may be obtained without scanning all valid updates of the cell.

According to still another aspect of the present invention, there is provided a method for obtaining the historical information of contents in an electronic spreadsheet document in a given time period, wherein the change-oriented method for organizing electronic spreadsheet data has been applied in the electronic spreadsheet document, the method comprising the following steps:
getting an area of the electronic spreadsheet document of which the historical information is to be obtained, a start timestamp and an end timestamp;
searching the locations of all the cells in the area and all valid updates corresponding to each cell;
obtaining all the valid updates of every cell within the period between the start timestamp and the end timestamp; and
obtaining the contents of the cells corresponding to the valid updates obtained in the previous step and the occurrence times of these updates as the historical information of the electronic spreadsheet document.

Preferably, the historical information is used as a data source for data analysis in electronic spreadsheet software, and the inputs of formulas in an electronic spreadsheet, and so on.

Preferably, using the occurrence times of updates as the abscissa and the updated contents of cells as the ordinate, a chart of the historical information of each cell is generated.

According to still another aspect of the present invention, there is provided a change-oriented electronic spreadsheet system, comprising:
spreadsheet data input/output means;
document storage means for storing electronic spreadsheet documents, wherein in each document are recorded the contents of all the cells in a corresponding electronic spreadsheet and valid updates, wherein the valid updates comprise the updates to the contents of the cells and the time information associated with these updates;
update judgment means for determining whether or not the data inputted from outside through the spreadsheet input/output means by a user is an valid update to the electronic spreadsheet, and if it is a valid update, then the data will be saved as a valid update into the document where the electronic spreadsheet resides in the document storage means; and
update querying means for querying valid updates that meet given conditions.

Preferably, the system further comprises: a user interface through which a user specifies whether valid updates are recorded for the whole electronic spreadsheet document or a spreadsheet, an area, a column, or a cell.

Preferably, the system further comprises a snapshot generator for taking a snapshot based on selected valid updates.

Preferably, the system further comprises a data analysis and presentation means for performing data analysis and presentation using selected valid updates as a data source.

Preferably, the data analysis and presentation means is a chart generator for generating a chart with times as the abscissa and updated cell contents as the ordinate.

### BRIEF DESCRIPTION OF THE DRAWINGS

Through the following detailed description in conjunction with the drawings, the present invention as well as its many advantages will be better understood without difficulty. The same notations represent the same or like components throughout these drawings.

FIG. 1 schematically shows a change-oriented method for organizing data of an electronic spreadsheet according to a preferred embodiment of the present invention.

FIG. 2 schematically shows a change-oriented method for organizing data of an electronic spreadsheet according to another preferred embodiment of the present invention.

FIG. 3 schematically shows a change-oriented method for organizing data of an electronic spreadsheet according to still another preferred embodiment of the present invention.

FIG. 4 is a flow chart showing a method for taking a snapshot of an electronic spreadsheet document at a given time according to a preferred embodiment of the present invention.

FIG. 5 is flow chart showing a method for obtaining the historical information of contents an electronic spreadsheet document in a given time period according to a preferred embodiment of the present invention.

FIG. 6 is a block diagram showing a change-oriented electronic spreadsheet system according to a preferred embodiment of the present invention.

### DETAILED DESCRIPTION OF THE INVENTION

It is believed that, through the following detailed description of preferred embodiments of the present invention in conjunction with the drawings, the above-mentioned and other objectives, features and advantages of the invention will be more apparent.

The basic idea of the invention is to provide a time dimension in an electronic spreadsheet document by recording every valid update and the update time to extend the electronic spreadsheet document into a time-related document, so that a snapshot of the electronic spreadsheet document at a specified time and the historical information of the electronic spreadsheet document in a specified time period can be obtained conveniently.

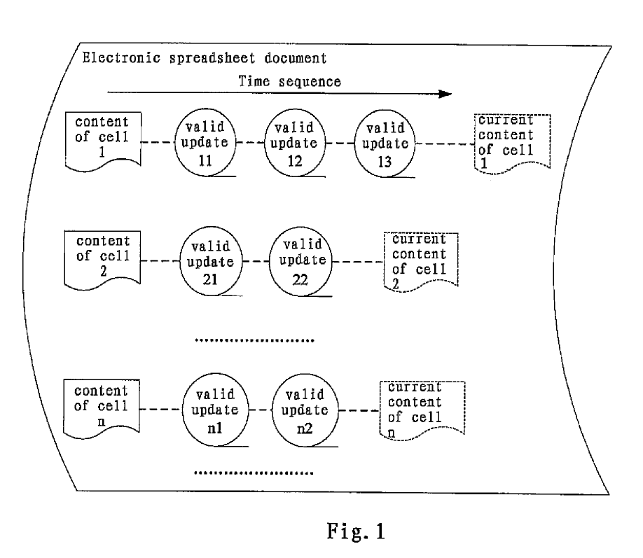

FIG. 1 schematically shows a change-oriented method for organizing data of an electronic spreadsheet according to a preferred embodiment of the present invention. Generally, in an electronic spreadsheet document contents are saved in the unit of cell, and in a prior art electronic spreadsheet document only current contents are saved in the cells. Actually, however, the current content of an electronic spreadsheet document may be divided logically into two parts, that is, the original contents and valid updates to the original contents. In the present invention, the original contents and valid updates to the original contents are saved in the same electronic spreadsheet document, wherein the valid updates comprise updates to the contents of cells and the time information associated with these updates. Preferably, the time information associated with the updates may be the occurrence times of the valid updates.

In the embodiment shown in FIG. 1, the valid updates are saved in the electronic spreadsheet document as auxiliary information of the corresponding cells in order of the occurrence times of the updates. The valid updates are saved together with the original contents of the cells as auxiliary information of the cells with the cells as an index; and for a same cell, its valid updates are arranged in order of the occurrence times of the updates. For instance, in a XML based electronic spreadsheet document, the update contents of a cell may be saved under a same tag as the original content and led by sub-tags. In addition, the current content of a cell may also be saved in the electronic spreadsheet document.

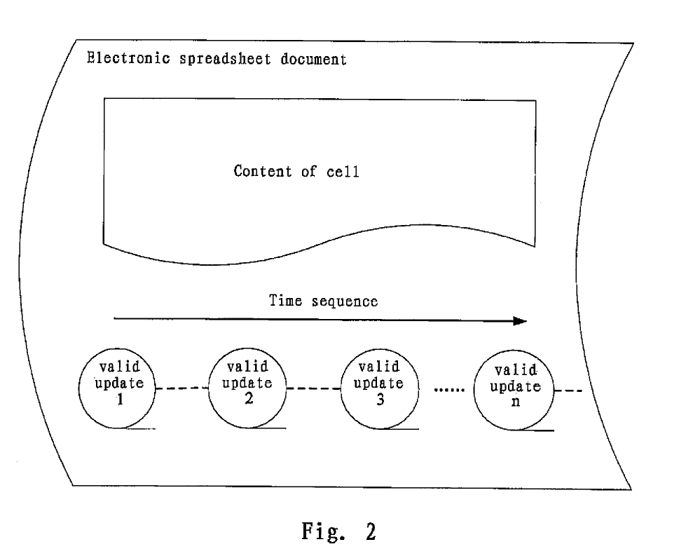

FIG. 2 schematically shows a change-oriented method for organizing data of an electronic spreadsheet according to another preferred embodiment of the present invention. In the present embodiment, valid updates are saved in the electronic spreadsheet document in order of the occurrence times of the updates and separately from the contents of the cells. The valid updates of the electronic spreadsheet document are saved separately from the contents of the cells and arranged in order of the occurrence times of the updates. In this method, in addition to the update of the content of the cell and the time information associated with the update, a valid update also includes a binding relationship between the valid update and the corresponding cell, that is, which cell in the electronic spreadsheet document the valid update corresponds to.

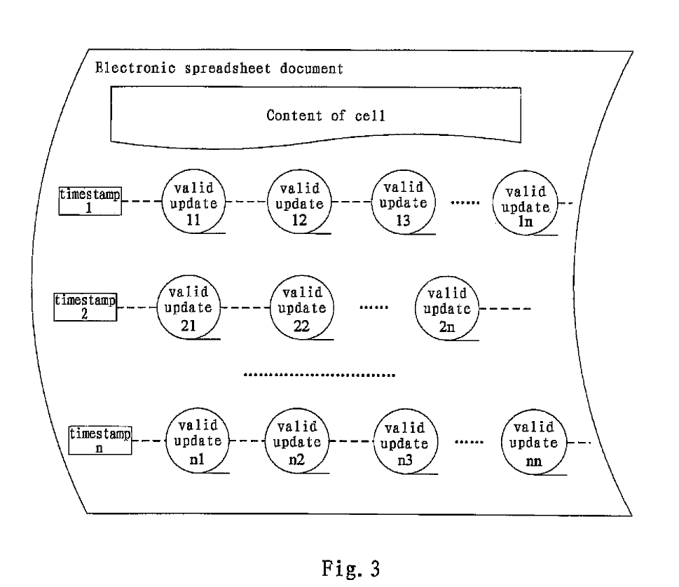

FIG. 3 schematically shows a change-oriented method for organizing data of an electronic spreadsheet according to still another preferred embodiment of the present invention. In the present embodiment, valid updates are saved according to the occurrence times of the updates as given by timestamps and separately from the content of the cells. The valid updates of an electronic spreadsheet document are saved separately from the contents of the cells, and these valid updates are arranged according to the corresponding timestamps. In other words, these valid updates are arranged with the timestamps as an index. In this way, how many valid updates there are at a given timestamp can be known, thus greatly facilitating later querying. Similar to the embodiment shown in FIG. 2, a valid update also includes a binding relationship between the valid update and the corresponding cell, that is, which cell in the electronic spreadsheet document the valid update corresponds to.

Following is an example showing an electronic spreadsheet document format extension, as illustrated by the example of saving valid updates shown in FIG. 1. The example employs the OASIS (Organization for the Advancement of Structured Information Standards) defined Office file format standard. The definition of a cell (before extension) given by OASIS is:

```
<define name=“table-table-cell”>
  <element name=“table:table-cell”>
    <ref name=“table-table-cell-attlist”/>
    <ref name=“table-table-attlist-extra”/>
    <ref name=“table-table-cell-content”/>
    <optional>
    <ref name=“table-table-cell-updaterecord”/>
    </optional>
  </element>
</define>
```

Whereas after extension of the field “optional”, the definition of a cell is:

```
<define name=“table-table-cell-updaterecord”>
  <element name=“table: cell-content-update-list”>
    <zeroOrMore>
        <ref name=“cell-update-info”/>
      </zeroOrMore>
  </element>
</define>
<define name=“cell-update-info”>
  <element name=“cell: update-info”>
    <ref name=“current-value”/>
    <ref name=“current-date”/>
    <optional>
      <ref name=“update-author”/>
        ...
    </optional>
  </element>
</define>
```

It should be noted that, in the present invention, the user may specify whether the valid updates are recorded for the whole electronic spreadsheet document or a spreadsheet, an area, a column, or a cell. Thus, the user can select whether the valid updates are recorded for a part of the electronic spreadsheet document or the whole electronic spreadsheet document. In the invention, a valid update is that which has been confirmed by the user. Valid updates are performed with a cell in the electronic spreadsheet document as the minimum unit, and are limited to raw data, not including derived data, such as a chart, the calculation result of a formula, etc. After an update operation, the update becomes a valid update only after the user has confirmed the update operation. The way in which the user confirms may be a saving to disk operation or another operation.

From the above description it can be seen that, by using the methods according to the above-mentioned embodiments, it is possible to record every valid update including time information to the cells in an electronic spreadsheet document, so as to provide a basis for applications of electronic spreadsheet documents, such as obtaining a snapshot, a chart of historical information, etc. Furthermore, the methods of the above-mentioned embodiments can be applied to the whole electronic spreadsheet document or a part of the electronic spreadsheet document according to the user's requirements.

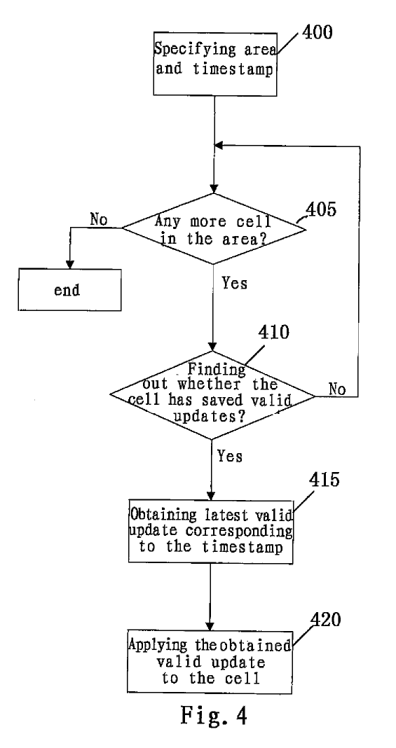

FIG. 4 is a flow chart showing a method for taking a snapshot of an electronic spreadsheet document at a given time according to a preferred embodiment of the present invention. By using the change-oriented method for organizing data of an electronic spreadsheet document, the contents of cells and valid updates can be saved in the electronic spreadsheet document so that useful operations can be performed more conveniently on the collection of the contents of cells, such as taking a snapshot of the electronic spreadsheet document at a given time. In an existing electronic spreadsheet application, it is required to record similar contents of the same template periodically, and such a set of electronic spreadsheet documents may be considered a set of snapshots (or photos). However, if the valid updates to the electronic spreadsheet document have been recorded by using the change-oriented method of the invention for organizing data of an electronic spreadsheet document, a valid update would be recorded whenever it occurs, which is an improvement over the case in which the time interval corresponding to recording a snapshot is selected by the user or periodically. As a result, the time granularity is greatly refined. Comparing these two approaches, the change is similar to that from a set of photos to a section of “video”, that is, all the valid updates occurred in a specified area and the corresponding update times would be recorded. When the whole “video” is saved in an electronic spreadsheet document as a hidden dimension, the most recently edited electronic spreadsheet document can be considered the latest snapshot. Thus, a specified time can be used as an index to obtain a snapshot of the electronic spreadsheet document.

As shown in FIG. 4, at Step 400, the user specifies an area of an electronic spreadsheet document of which a snapshot is to be taken and a timestamp, wherein the area includes at least one cell. Then at steps 405 and 410, in the electronic spreadsheet document all cells in the area are searched to determine whether any cell has any valid updates that have been saved. If the answer is no, with no cell having any saved valid update, the process of taking a snapshot is ended. If the answer is “yes”, then at Step 415, the valid updates of every cell are scanned to obtain the latest valid update of each cell corresponding to the specified timestamp. According to the change-oriented method of the invention for organizing data of an electronic spreadsheet document, these valid updates are all arranged in order of time, so that in respect of each cell, if it is found that the update occurrence time corresponding to a valid update is smaller than the timestamp and the update occurrence time corresponding to the subsequent valid update is larger than the timestamp or there is no valid update thereafter, then this valid update is the latest valid update corresponding to the timestamp. Then at Step 420, the valid updates obtained at Step 415 are applied to every cell. At this point, every cell is restored to the saved content at the specified timestamp. After such processing of every cell, a snapshot of the electronic spreadsheet document for a user-specified area and at a specified time is obtained.

From the above description it can be seen that, with the method of the present embodiment, a snapshot of a specified area at a specified time can be easily obtained from an electronic spreadsheet document using the method of the present invention.

Since the electronic spreadsheet document is extended to be related to a hidden time dimension, time-related historical information of the electronic spreadsheet document for a specified area may be obtained. Changes of the electronic spreadsheet document for a specified area during a time period are recorded in the historical information, which can be used as a data source for data analysis functions in electronic spreadsheet applications, such as inputs of a formula or for regression analysis etc., and can be expressed with charts or in other obvious ways. For instance, a chart reflecting the historical information of the content of each cell can be produced with the update occurrence times as the abscissa and the updated contents of the cell as the ordinate.

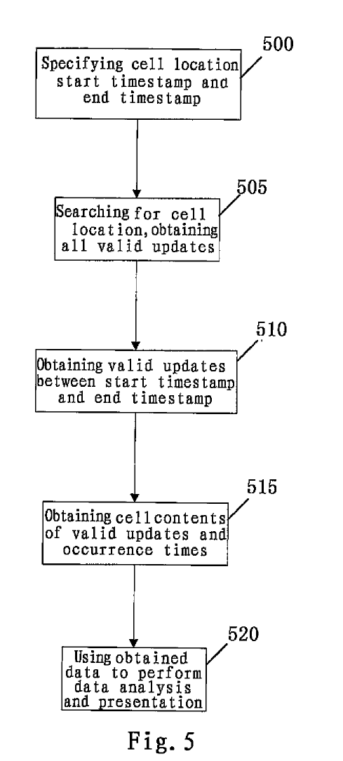

FIG. 5 is a flow chart showing the method for obtaining the historical information of an electronic spreadsheet document in a given time period according to a preferred embodiment of the present invention. In the present embodiment, a specified area is a cell of the electronic spreadsheet document. As shown in FIG. 5, at Step 500, the user specifies the location of a cell of which the historical information is to be obtained and start and end timestamps of the historical information, wherein the time period of the historical information is determined by the start and end timestamps. Then at Step 505, the location of the cell is found in the electronic spreadsheet document and all the valid updates corresponding to the cell are obtained. Since the valid updates are arranged in order of time, at Step 510, all the valid updates between the start and end timestamps can be obtained, so that, at Step 515, the cell content of every valid update in the valid updates obtained at Step 510 and the occurrence time of the update can be obtained as the historical information of the electronic spreadsheet document. Finally, at Step 520, the historical information is used as a data source for data analysis in electronic spreadsheet software, as the inputs of formulas in an electronic spreadsheet and so on. Preferably, a chart of the historical information of each cell is generated with the occurrence times of updates as the abscissa and updated contents of the cell as the ordinate.

In addition, in the method for obtaining the historical information of an electronic spreadsheet document in a given time period according to a preferred embodiment of the present invention, an area that contains a plurality of cells may be specified by the user and for each cell in the specified area the historical information of the electronic spreadsheet document in a given time period may be obtained.

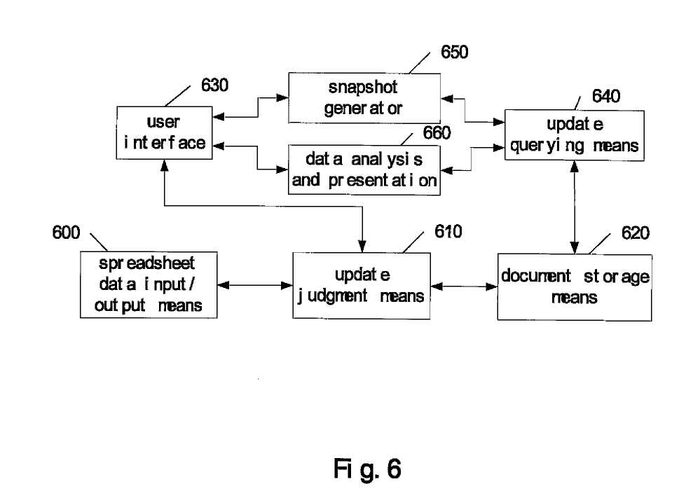

FIG. 6 is a block diagram showing the change-oriented electronic spreadsheet system according to a preferred embodiment of the present invention. As shown in FIG. 6, the system comprises: spreadsheet data input/output means 600; document storage means 620 for storing electronic spreadsheet documents, wherein in each document are recorded the content of every cell in a corresponding electronic spreadsheet and the valid updates as well as the updating times; update judgment means 610 for determining whether or not the data inputted from outside through the spreadsheet input/output means 600 by a user is a valid update to the electronic spreadsheet. If it is a valid update, then the data will be saved as a valid update into the document where the electronic spreadsheet resides in the document storage means 620. An update querying means 640 is provided for querying cells at specified locations and all their valid updates according to a received request from the user. In a document, if there are more than one valid update, these valid updates will be arranged in order of time, for instance, according to the order of data saving times or according to the data saving times as give by the timestamps.

The system may further comprise a user interface 630 through which a user may specifies whether the valid updates are recorded for the whole electronic spreadsheet document or a spreadsheet, an area, a column, or a cell; a snapshot generator 650 for taking a snapshot according to a received user request; data analysis and presentation means 660 for using the historical information, comprising the updated contents in a specified time range and the time information corresponding to these updates, as a data source for data analysis in electronic spreadsheet software, inputs to an electronic spreadsheet formula and so on according to a received user request. Preferably, the data analysis and presentation means is a chart generator for generating a chart of the historical information of every cell with the occurrence times of the updates as the abscissa and updated cell contents as the ordinate.

From the above description it can be seen that, with the system of the present embodiment, every valid update of the cells and the time of the update may be saved, so as to facilitate the subsequent time-based querying of the electronic spreadsheet.

What is claimed is:

1. A change-oriented method for organizing electronic spreadsheet data, comprising:
saving contents of cells in the electronic spreadsheet and valid updates into the same electronic spreadsheet document, wherein the valid updates comprise updates to the contents of the cells and time information associated with the updates.

2. The change-oriented method for organizing electronic spreadsheet data according to claim 1, wherein the time information associated with each valid update comprises an occurrence time of the valid update.

3. The change-oriented method for organizing electronic spreadsheet data according to claim 2, wherein the valid updates are saved as auxiliary information of the corresponding cells in order of the occurrence times of the valid updates.

4. A change-oriented method for organizing electronic spreadsheet data according to claim 1, wherein the valid updates are saved according to the update times and separately from the contents of the cells, and wherein binding relationships between the valid updates and the corresponding cells are also saved.

5. The change-oriented method for organizing electronic spreadsheet data according to claim 1, wherein the valid updates are saved according to occurrence times of the updates as given by timestamps and separately from the content of the cells, and wherein binding relationships between the valid updates and the corresponding cells are also saved.

6. The change-oriented method for organizing electronic spreadsheet data according to claim 1, further comprising: specifying whether the valid updates are saved for a whole electronic spreadsheet document or a spreadsheet, an area, a column, or a cell.

7. A method for taking a snapshot of an electronic spreadsheet document at a given time, wherein the change-oriented method for organizing electronic spreadsheet data according claim 1 has been applied in the electronic spreadsheet document, the method comprising:
obtaining an area of the electronic spreadsheet document of which a snapshot is to be taken and a timestamp;
searching every cell in the area to determine whether or not there is any saved valid update;
if any saved valid update is found, obtaining the latest valid update of every cell corresponding to the timestamp;
applying the obtained valid updates to every corresponding cell;
if no cell has any saved valid update or the applying step has been performed for every cell, ending the process of taking a snapshot of the electronic spreadsheet document.

8. The method for taking a snapshot of an electronic spreadsheet document at a given time according to claim 7, wherein the step of obtaining the latest valid update of every cell corresponding to the timestamp comprises:
scanning all the valid updates of the cell;
if the update occurrence time corresponding to a valid update is smaller than the timestamp and the update occurrence time corresponding to the subsequent valid update is larger than the timestamp or there is no valid update later in order of time, then this valid update is the latest valid update of the cell corresponding to the specified timestamp; and
if the latest valid update of the cell corresponding to the specified timestamp is found, the scanning is ended.

9. A method for obtaining the historical information of contents in an electronic spreadsheet document in a given time period, wherein the change-oriented method for organizing electronic spreadsheet data according claim 1 has been applied in the electronic spreadsheet document, the method comprising:
obtaining an area of the electronic spreadsheet document of which historical information is to be acquired, a start timestamp, and an end timestamp;
searching locations of all the cells in the area and all valid updates corresponding to each cell;
obtaining all the valid updates of every cell within a period between the start timestamp and the end timestamp; and
obtaining the contents of the cells corresponding to the obtained valid updates and the occurrence times of the obtained valid updates as the historical information of the electronic spreadsheet document.

10. The method for taking a snapshot of an electronic spreadsheet document at a given time according to claim 9, further comprising:
using the historical information as a data source for data analysis in electronic spreadsheet software.

11. The method for taking a snapshot of an electronic spreadsheet document at a given time according to claim 10, further comprising:
generating charts of the historical information of the cells by using the occurrence times of the updates as the abscissa and the updated contents of cell as the ordinate.

12. A change-oriented electronic spreadsheet system, comprising:
spreadsheet data input/output means;
document storage means for storing electronic spreadsheet documents, wherein in each document are recorded contents of all cells in a corresponding electronic spreadsheet, valid updates, and update times;
update judgment means for determining whether or not data inputted by a user through the spreadsheet input/output means is a valid update to the electronic spreadsheet, and if it is a valid update, then the data is saved as a valid update into the document where the electronic spreadsheet resides in the storage means; and
update querying means for querying valid updates that meet given conditions.

13. The change-oriented electronic spreadsheet system according to claim 12, further comprising a user interface through which a user specifies whether the valid updates are saved for the whole electronic spreadsheet document or a spreadsheet, an area, a column, or a cell.

14. The change-oriented electronic spreadsheet system according to claim 12, further comprising a snapshot generator for taking a snapshot at a specified time based on a received request.

15. The change-oriented electronic spreadsheet system according to claim 12, further comprising a data analysis and presentation means for using the historical information, including the updated contents within a specified time range and the time information corresponding to these updates, as a data source for data analysis in electronic spreadsheet software.

16. The change-oriented electronic spreadsheet system according to claim 15, wherein the data analysis and presentation means is a chart generator for generating a chart reflecting the historical information of a cell with the occurrence times of updates as the abscissa and updated cell contents as the ordinate.
